(19) United States
(12) Patent Application Publication
(10) Pub. No.: US 2026/0094169 A1
(43) Pub. Date: Apr. 2, 2026

(54) METAL RECOVERY AND REGENERATION PRODUCTION HISTORY RECORDING APPLICATION PROGRAM WITH CARBON DISCLOSURE FUNCTION

(71) Applicant: HF investment Ltd., Taichung City (TW)

(72) Inventor: CHIEN-HAO LEE, Taichung City (TW)

(21) Appl. No.: 19/110,908

(22) PCT Filed: Oct. 10, 2022
(86) PCT No.: PCT/CN2022/131046

§ 371 Date: Mar. 12, 2025

(51) Int. Cl. G06Q 30/018; G06Q 10/30

(52) U.S. Cl. CPC G06Q 30/018; G06Q 10/30

(57) ABSTRACT

An application for metal recycling and regeneration production traceability with carbon disclosure is installed on a device and executes a method. The device is signal-connected to a server. The method includes steps of: displaying a user interface to receive necessary carbon disclosure data, initiating a recycling program on the server, and generating corresponding labels along with an access node for each of the label; reading each of the label via barcode recognition or image recognition and obtaining access permissions for multiple access nodes associated with the labels from the server; receiving or obtaining data of audio-visual information or detection, transmitting the data to the server, and recording the data in the corresponding access node; displaying the data by retrieving the access node from the server and presenting at least material comparison results, raw material production history, grade compensation, real-time carbon data, or carbon certificates through the user interface.

### FIELD OF INVENTION

The present invention relates to an application for metal recycling, particularly to an application for metal recycling and regeneration production traceability with carbon disclosure.

### BACKGROUND OF THE INVENTION

The Oxford Dictionary's 2019 Word of the Year, climate emergency, signifies the growing public recognition of the severe threat posed by global warming and its resulting extreme weather conditions. Human economic activities are the primary contributors to the significant increase in greenhouse gas emissions, which in turn drive the greenhouse effect. As a response, international agreements such as the Paris Agreement and the Kyoto Protocol aim to set timelines for achieving carbon peaking, encouraging industrial production and economic activities within countries to reach carbon neutrality. To achieve the goal of carbon neutrality and mitigate the potential increase in operational costs caused by measures such as the EU's Carbon Border Adjustment Mechanism (CBAM) and other carbon taxes, many companies have already begun efforts to reduce carbon emissions during their production processes.

While many companies express a desire to reduce carbon emissions, most lack sufficient knowledge and direction, often resorting to superficial actions such as recycling materials, planting trees, or installing solar panels. A responsible company committed to reducing carbon emissions must first identify and quantify the carbon emissions across every stage of its production process, known as a “carbon inventory.” Unfortunately, although small and medium-sized enterprises are increasingly aware of the need for carbon inventories, the actual implementation of carbon assessments across supply chain production processes remains poor, not to mention the evaluation of recycled materials and regeneration processes.

### SUMMARY OF THE INVENTION

To address the issues, this present invention discloses an application for metal recycling and regeneration production traceability with carbon disclosure, wherein the application is installed on a device and executes a method for metal recycling and regeneration production traceability with carbon disclosure, and the device is signal-connected to a server, wherein the method comprises steps of: displaying a user interface to receive input of carbon disclosure data, initiating a recycling program on the server, and generating one or more corresponding labels along with an access node for each label; reading each of the label with barcode recognition or image recognition and obtaining access permissions for the access nodes corresponding to the labels from the server; receiving or obtaining audio-visual or inspection data, transmitting the data to the server, and recording the data in the corresponding access node; and displaying the data, retrieving the access node from the server, and obtaining at least material comparison results, raw material production history, grading compensation, real-time carbon data, or carbon certificates through the user interface.

Wherein, the device comprises a mobile phone, a tablet device, a computer, or a smartwatch.

Wherein, the device is wired to a physical or chemical parameter detection device and an audio-visual acquisition device to obtain carbon disclosure-related parameters.

Wherein, the device is wirelessly connected to a physical or chemical parameter detection device and an audio-visual acquisition device to obtain carbon disclosure-related parameters.

Wherein, after identity recognition, access permissions and required input information items corresponding to the access node are generated.

Based on the aforementioned description, the present invention has the following advantages:
1. The present invention comprehensively records the carbon footprint generated during the waste recycling process, systematically producing fair and transparent records in line with ISO principles. This enhances the fairness and reliability of future carbon certificates and fully addresses the issues of existing technologies.
2. The present invention cleverly utilizes monitoring and standard packaging during the recycling and regeneration process, effectively generating production traceability and carbon emission records simultaneously with the output of recycled products. This achieves an intelligent carbon inventory and tracking system with unexpected results.

### BRIEF DESCRIPTION OF THE DRAWINGS

FIG. 1 is a schematic diagram of a preferred embodiment in accordance with the present invention.

### DETAILED DESCRIPTION OF THE PREFERRED EMBODIMENTS

To make it easier for our examiner and people having ordinary skill in the art to understand the technical characteristics of the invention, we use preferred embodiments together with the attached drawings for the detailed description of the invention, in which like reference numerals refer to like parts or operations. It is noteworthy that the embodiments and drawings are used for the purpose of describing and illustrating the technical characteristics of the invention, but not intended to limit the scope of the invention.

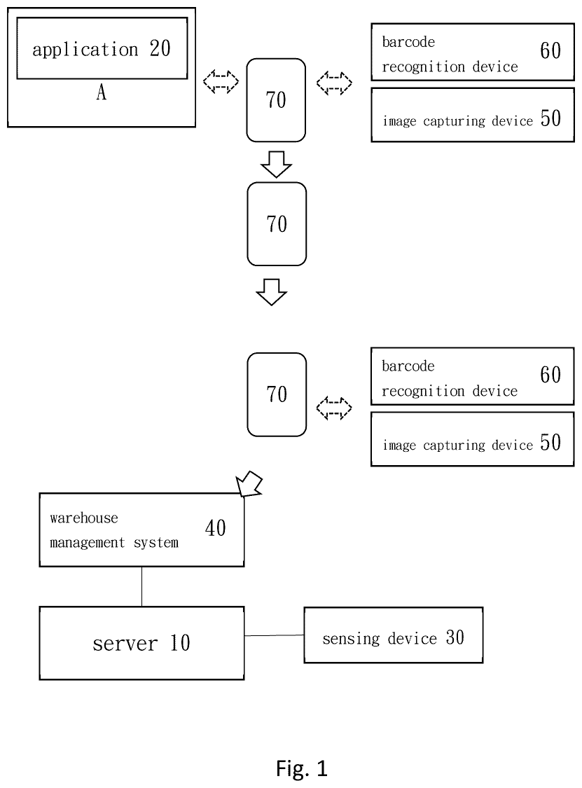

With reference to FIG. 1, a metal recycling and regeneration production traceability system with carbon disclosure is shown. The metal recycling and regeneration production traceability system includes a server 10, one or more applications 20, a sensing device 30, a warehouse management system 40, an image capturing device 50, a barcode recognition device 60, and multiple standard packagings 70. Each of the application 20 is signal-connected to the server 10, enabling signal transmission and communication for interaction and control between the server 10 and each of the application 20. Each of the sensing device 30 is also signal-connected to the server 10, and transmits detection results to the server 10 for recording. The detection results include, but are not limited to, physical or chemical properties such as weight, material, purity, density, metallography, composition, elements, and lattice structure. In other words, the sensing device 30 may include equipment such as weighing scales, elemental analyzers, optical imaging monitors, X-ray diffraction devices, or EDS (Energy Dispersive Spectroscopy) analyzers.

The warehouse management system 40 is signal-connected to the server 10. The warehouse management system 40 includes a storage space for the storage, input, output, total quantity control, and management of materials. The materials can be various types, units, and capacities, each stored in the standard packaging 70. In addition, the warehouse management system 40 also records a greenhouse gas emission history associated with each standard packaging 70 during storage. The greenhouse gas emission may relate to direct greenhouse gas emissions, input energy (air conditioning, lighting, robotic transport, monitoring and management), transportation (forklifts, cranes, company vehicles, trucks, tankers), and other sources. For example, the greenhouse gases generated during the operation of the warehouse management system 40 are allocated to the greenhouse gas emission history of each standard packaging 70. The server 10 retrieves information about the contents of each standard packaging 70 and the associated greenhouse gas emission history from the warehouse management system 40.

Multiple of the image capturing devices 50 and the barcode recognition devices 60 are used to continuously record the entire lifecycle of the standard packaging 70 from production to disposal. The image capturing devices 50 and the barcode recognition devices 60 can be installed at various locations, such as external factories, transport trucks, the storage space, and recycling plants, to document processes involving the production, transportation, storage, and remanufacturing of the standard packaging 70. The image capturing devices 50 and the barcode recognition devices 60 are signal-connected to the server 10. The image capturing devices 50 and the barcode recognition devices 60 acquire digital audio-visual information and recognize a label on each standard packaging 70, generating a recognition result. The recognition result is then transmitted to the server 10. The digital audio-visual information includes, but is not limited to, voice, video, and photographs.

Preferably, during the filling, production, use, and transfer processes of the standard packaging 70, the digital audio-visual information and the recognition results from the image capturing device 50 and the barcode recognition device 60 can be output to the server 10 through the application 20. The application 20 can be installed on a mobile device A, such as one operated by a driver during transportation. The driver can use the built-in image capturing device 50 and the barcode recognition device 60 on the mobile device A to acquire the digital audio-visual information and the recognition results. The recognition results are then updated to the server 10 through the application 20, corresponding to a carbon data report of the standard packaging 70.

### An Embodiment: Recycled Aluminum Chips

One or more of the image capturing devices 50 and the barcode recognition devices 60 are installed on processing equipment in a CNC machine factory. The aluminum chips, with fixed weight and material (such as 7075, 6061 aluminum alloys, etc., 10 kilograms per package), are filled into standard packaging 70. The standard packaging 70 contains a digital label, such as an RFID tag or a QR code. After scanning and recognizing the barcode, the barcode recognition device 60 sends the digital audio-visual information recorded by the image capturing device 50 back to the server 10. This updates the recycling information of the aluminum chips in the factory to the server 10, corresponding to the carbon data report of the standard packaging 70. Therefore, the carbon data report corresponding to each standard packaging 70 starts with the recycled material filled into the standard packaging 70, and continuously monitored through data collection and recording process with digital audio-visual information, ensuring data accuracy and reducing disputes.

A company purchases the standard packaging 70 from the CNC machining factory at a standard market price. A purchase price is recorded in the server 10, corresponding to the carbon data report of the standard packaging 70. The company assigns a transportation vehicle to deliver the standard packaging 70 to the warehouse management system 40 for storage. During transportation, the model of the vehicle, mileage, and fuel consumption are recorded. By scanning the label on the standard packaging 70, the data is output and recorded in the carbon data report corresponding to the standard packaging 70.

Accordingly, when the standard packaging 70 is stored in the warehouse management system 40, monitoring data is updated in the corresponding carbon data report through imaging and scanning. Since the weight and space of the standard packaging 70 are fixed, the carbon emissions from the equipment used during transportation can be calculated and recorded in the carbon data report. Additionally, the storage duration and occupied space in the warehouse are fixed and estimable values. This allows the carbon emissions associated with the aluminum chips inside the standard packaging 70, from generation to transportation and storage, to be accurately and reliably documented in the carbon data report. The carbon data report can also be continuously updated to reflect a carbon emission history of the standard packaging 70 through the combined use of image recording and scanning recognition.

The company retrieves the standard packaging 70 from the warehouse management system 40, conducts a detection of the standard packaging 70 to determine the material purity and composition, assigns a purity grade to the aluminum chips within the standard packaging 70, and records this information in the carbon emission history.

Furthermore, after completing the purity grading, the company may refer to the standard market price at the time of purchase and provide a grade compensation to the CNC factory based on the purity grade of the aluminum chips.

The company processes the aluminum chips from the multiple standard packagings 70 through a reprocessing procedure. During the reprocessing procedure, impurities are removed, required elements are added, and the aluminum chips are melted, decomposed, blended, and refined into an aluminum alloy melt. The aluminum alloy melt is then solidified to form aluminum ingots. Throughout the reprocessing procedure, the carbon emissions directly or indirectly generated by the equipment used are recorded and evenly allocated to the carbon emissions associated with the reprocessing procedure. The records are documented in a carbon data of the aluminum ingot and stored in the server 10. In this manner, the carbon data and production history of each aluminum ingot produced from the recycled aluminum chips can be systematically and effectively recorded in the server 10.

Furthermore, another standard packaging 70 can be utilized, along with the aforementioned recording and scanning methods, to continuously document the emissions generated during the sales process of the aluminum ingot until the aluminum ingot reaches a buyer. These records are stored in the carbon data report corresponding to the standard packaging 70 of the aluminum ingot. As the recording of the aforementioned process is clear, and each step of the procedure is impartially and effectively audited and documented, a carbon certificate corresponding to the aluminum ingot can be directly generated upon shipment.

Based on the above description, this invention discloses a method for metal recycling and regeneration production traceability with carbon disclosure at the same time. The method for metal recycling and regeneration production traceability with carbon disclosure includes steps of:
providing a standard packaging 70, wherein the standard packaging 70 includes a label;
filling a recycled material into the standard packaging 70 while scanning a label on the standard packaging 70 to obtain an access node of a carbon data report, and recording a physical or chemical detection result of the recycled material, a real-time filling image, a carbon footprint history, and factory recycling information at the access node; In some embodiments, the access node is provided by the server 10, and the carbon footprint history includes but is not limited to carbon emissions directly or indirectly generated by personnel or transportation tools.
recording a standard market price of the standard packaging 70, transporting the standard packaging 70, storing the standard packaging 70 in a storage space, and simultaneously scanning the label to obtain the access node, recording a storage time of the standard package 70 in the storage space and the carbon emissions generated directly or indirectly, and storing data of the storage time and the carbon emissions in the carbon data report;
performing a detection and analysis on the recycled material within the standard packaging 70 to determine a purity grade of the recycled material, and recording the purity grade in the carbon data report of the access node;
generating a grade compensation based on the purity grade and with reference to the standard market price;
processing the recycled materials from multiple of the standard packagings 70 with identical physical or chemical properties through a reprocessing procedure for modification and mixing, while scanning the code and recording the carbon emissions of the reprocessing procedure in the carbon data report;
evenly distributing all the records of the carbon emissions from the carbon data reports among the regenerated products produced by the reprocessing procedure, and generating a finished product carbon emission record, a traceability report, and a carbon certificate for the regenerated products.

The application 20 enables the mobile device A to execute a recording method for metal recycling and regeneration production traceability with carbon disclosure. The mobile device A includes, but is not limited to, a mobile phone, a tablet device, a computer, or a smartwatch. Preferably, the mobile device A is able to connect to the internet, acquire audio-visual data, connect to multiple detection devices, and perform data transmission, allowing real-time data acquisition and output to the server 10 to assist in calculating the carbon emissions in the metal recycling and regeneration process. The mobile device A is used by users of different roles. The mobile device A helps the users execute functions such as recycling, reprocessing, and carbon emission calculations. For example, a transportation service provider can use a handheld mobile device A to continuously monitor waste loading and unloading, record fuel consumption, mileage, and route tracking. Similarly, a manufacturer of aluminum ingots can use an on-site mobile device A to record analysis of material, direct emissions such as from production line equipment, or indirect emissions such as from labor or ambient lighting. The mobile device A used by the users of different roles can transmit recorded data back to the server 10, enabling each of the mobile devices A used by the users to instantly access reliable carbon emission data for different stages, thereby compiling and disclosing data across the upstream and downstream supply chains.

In one embodiment, the steps of the method for metal recycling and regeneration production traceability with carbon disclosure may include:
S1. Receiving an input applying for waste material recycling: The application provides a user interface. The users can obtain necessary information, such as quantity of recyclable waste, manufacturer, address, material type, personnel, transportation vehicles, and other essential carbon disclosure data through the user interface. The application launches a recycling program and reports to the server 10, making the server 10 to open or generate the access node (or database) corresponding to the label.
S2. Acquiring the label: The server 10 obtains the label and the standard packaging 70, completes the filling of the recyclable material, and simultaneously inputs relevant information about the recyclable material, such as material type, weight, density, and other known chemical or physical parameters. The acquisition of the label in this step enables the users at different stages of the overall recycling process to use the same label to identify and read the information recorded in the standard packaging 70 and continuously update the records throughout the process (e.g., energy consumption during transportation, warehouse energy consumption, labor).
S3. Recognizing a barcode: Users at different stages utilize the application 20 and corresponding hardware devices, such as a camera or a scanner, to recognize the barcode using the barcode recognition device 60 or image recognition. This process enables reading and updating the information associated with the barcode of the standard packaging 70 and the recyclable material.
S4. Recording waste recycling process: The mobile device A connects to or utilizes various detection devices capable of recording images, audio, and weight, continuously documenting data related to carbon consumption handled by the different users. The images and audio may be captured by a camera or audio module integrated into the mobile device A in this step. The weight detection device can either automatically receive measurement data from a weight detection device or allow manual input of weight measurement data. Preferably, in this embodiment, the mobile device A can connect to various external detection devices and receive measurement results via wired or wireless connections. The measurement results include weight, metallography, composition analysis, purity, etc.
E.g., transportation: Using the mobile device A, the user scans the tag on the standard packaging 70 with the camera, records the loading and unloading trucks, estimates the total weight of the truck, calculates the carbon consumption based on different load weights, and continuously records the travel distance and time via the mobile device A to track fuel consumption. This completes the carbon consumption record for the transportation phase between site A and site B, ensuring a comprehensive record of the carbon footprint of the recycled material.
E.g., storage: Upon warehouse entry, the mobile device A is used to scan each of the barcodes individually during truck unloading, recording the total number of the standard packagings 70 entering the warehouse. During material retrieval for outbound processing, each of the barcode of the standard packagings 70 is scanned again to estimate the storage duration of each unit of the standard packagings 70 in the warehouse. The corresponding carbon consumption data is then recorded in the file in the database linked to the label.
E.g., inspection: Using the mobile device A, the label is scanned to access the corresponding standard packaging 70. The contents of the standard packaging 70 are then inspected, and their chemical or physical parameters are recorded. Preferably, these chemical or physical parameters can be obtained in a manner similar to the aforementioned methods, either through wired or wireless connections to inspection equipment.

Furthermore, to prevent confusion in data access during the recycling process or erroneous edits to the access nodes or the database corresponding to each of the label, each standard packaging 70 is assigned specific access and data entry permissions from the initiation of the recycling process. These permissions vary across the different users involved in the recycling process, such as waste-generating manufacturers, transport vehicles and drivers, warehouse storage personnel, and equipment operators at various processing stages. For instance, transport personnel using the user interface can view serial number of the labels of the standard packagings 70 scheduled for processing that day, ensuring the accuracy of the transported contents. At each stage, the users can access, input, or upload data relevant to their responsibilities within the designated access node for each of the labels. This structured approach ensures that the carbon emissions generated at each phase of the recycling process are systematically and accurately recorded, minimizing errors. In other words, each of the users, upon identity verification (e.g., through an account with specific permissions), can use the application 20 to open and update the access node corresponding to the standard packaging 70 they handle. This allows for the continuous and complete recording of the recycling process and related data, ensuring that the server 10 accurately logs the entire operation.
E.g., processing: The processing stage may involve multiple procedures, such as melting and casting. During processing, time, energy consumption, and labor usage are recorded. In this stage, the raw materials in more than one standard packaging 70 may be used simultaneously in the reprocessing procedure. Therefore, multiple standard packagings 70 and their corresponding labels can be introduced together into the processing workflow. Once processing begins, the server 10 generates a new label and corresponding database to document the carbon emissions and related parameters throughout the new regeneration process. These records are stored under the newly created label and database, ensuring a systematic tracking of carbon consumption during processing.
S5. Displaying data: At each stage, the users can scan the barcode to access and retrieve various types of information, including material comparison results, raw material production history, grade compensation, real-time carbon data, and carbon certificates.

Based on the aforementioned description, the present invention has the following advantages:
1. The present invention of the application for metal recycling and regeneration production traceability with carbon disclosure comprehensively records the carbon footprint generated during the waste recycling process, systematically producing fair and transparent records in line with ISO principles. This enhances the fairness and reliability of future carbon certificates and fully addresses the issues of existing technologies.
2. The present invention cleverly utilizes monitoring and standard packaging during the recycling and regeneration process, effectively generating production traceability and carbon emission records simultaneously with the output of recycled products. With the application in accordance with the invention, an intelligent carbon inventory and convenient record tracking with unexpected results are achieved.

While the invention has been described by means of specific embodiments, numerous modifications and variations could be made thereto by those skilled in the art without departing from the scope and spirit of the invention as set forth in the claims.

1. An application for metal recycling and regeneration production traceability with carbon disclosure, wherein the application is installed on a device and executes a method for metal recycling and regeneration production traceability with carbon disclosure, and the device is signal-connected to a server, wherein the method comprises steps of:
displaying a user interface to receive input of carbon disclosure data, initiating a recycling program on the server, and generating one or more corresponding labels along with an access node for each label;
reading each of the label with barcode recognition or image recognition and obtaining access permissions for the access nodes corresponding to the labels from the server;
receiving or obtaining audio-visual or inspection data, transmitting the data to the server, and recording the data in the corresponding access node; and
displaying the data, retrieving the access node from the server, and obtaining at least material comparison results, raw material production history, grading compensation, real-time carbon data, or carbon certificates through the user interface.

2. The application for metal recycling and regeneration production traceability with carbon disclosure according to claim 1, wherein the device comprises a mobile phone, a tablet device, a computer, or a smartwatch.

3. The application for metal recycling and regeneration production traceability with carbon disclosure according to claim 2, wherein the device is wired to a physical or chemical parameter detection device and an audio-visual acquisition device to obtain carbon disclosure-related parameters.

4. The application for metal recycling and regeneration production traceability with carbon disclosure according to claim 2, wherein the device is wirelessly connected to a physical or chemical parameter detection device and an audio-visual acquisition device to obtain carbon disclosure-related parameters.

5. The application for metal recycling and regeneration production traceability with carbon disclosure according to claim 1, wherein after identity recognition, access permissions and required input information items corresponding to the access node are generated.

6. The application for metal recycling and regeneration production traceability with carbon disclosure according to claim 2, wherein after identity recognition, access permissions and required input information items corresponding to the access node are generated.

7. The application for metal recycling and regeneration production traceability with carbon disclosure according to claim 3, wherein after identity recognition, access permissions and required input information items corresponding to the access node are generated.

8. The application for metal recycling and regeneration production traceability with carbon disclosure according to claim 4, wherein after identity recognition, access permissions and required input information items corresponding to the access node are generated.
